(19) United States
(12) Patent Application Publication
(10) Pub. No.: US 2025/0290714 A1
(43) Pub. Date: Sep. 18, 2025

(54) METHOD FOR CONTROLLING A COMPRESSOR INSTALLATION AND COMPRESSOR INSTALLATION

(71) Applicant: ATLAS COPCO AIRPOWER, NAAMLOZE VENNOOTSCHAP, Wilrijk (BE)

(72) Inventors: Thibault CREPAIN, Wilrijk (BE); Geert HELLEMANS, Wilrijk (BE)

(73) Assignee: ATLAS COPCO AIRPOWER, NAAMLOZE VENNOOTSCHAP, Wilrijk (BE)

(21) Appl. No.: 18/860,967

(22) PCT Filed: Apr. 28, 2023
(86) PCT No.: PCT/IB2023/054430

§ 371 Date: Oct. 28, 2024

(30) Foreign Application Priority Data
May 5, 2022 (BE) 2022/5343

(51) Int. Cl. F28F 27/00; B01D 53/26; B01D 53/30

(52) U.S. Cl. CPC F28F 27/00; B01D 53/26; B01D 53/30; B01D 2257/80; B01D 2258/06; F28F 2250/08

(57) ABSTRACT

Compressor installation with at least two compressor elements in which the last compressor element is connected via a pressure line to the penultimate compressor element. An outlet line is connected to the outlet of the last compressor element and an intercooler is provided in the pressure line. The compressor installation includes a dryer for drying the compressed gas, the dryer provided with a drying section which is connected to the outlet line and with a regeneration section. A regeneration line is connected to the inlet of the regeneration section, which departs from a branch point of the outlet line, and the compressor installation is provided with a heat exchanger located in the pressure line downstream of the intercooler, in which the compressor installation is provided with means for controlling the heat exchanger, and the compressor installation is provided with a control unit for controlling the means.

The present invention relates to a method for controlling a compressor installation.

More specifically, the invention is intended for controlling a compressor installation comprising at least two compressor elements arranged in series, wherein an outlet line is connected to the outlet of the last of the compressor elements arranged in series, wherein an intercooler is provided between the compressor elements, wherein the compressor installation is further provided with a dryer of the type using a drying agent or desiccant for drying the compressed gas originating from the compressor installation, wherein the dryer is provided with a drying section with an inlet connected to said outlet line and with an outlet for dried compressed gas and with a regeneration section with an inlet and an outlet for a regeneration gas, wherein a regeneration line is connected to the inlet of the regeneration section, which regeneration line is connected to the outlet line.

Such compressor installations, in which use is made of the hot compressed gas originating from the last compressor element for the regeneration of the drying agent, are already known.

It is necessary that the temperature of this gas is sufficiently high to ensure sufficient regeneration of the drying agent.

Depending on the environmental parameters and the operating condition of the compressor elements and the dryer, the temperature of the regeneration gas may be too low to achieve proper regeneration of the drying agent.

This has the disadvantage that the drying agent cannot be regenerated properly, such that not only the next drying cycle will be performed less optimally because drying has to be done with a drying agent that still contains moisture, but also because moisture can build up in the dryer.

To remedy this, in some cases an electric heater is provided in the regeneration line for heating the regeneration gas. When an unfavourable situation occurs, this electric heater is turned on to ensure that the temperature of the regeneration gas is increased.

This is accompanied by additional and undesired energy consumption.

Another way to remedy this is to reduce the cooling capacity of said intercooler in these circumstances.

Reducing the cooling capacity of the intercooler results in the temperature of the compressed gas at the outlet of the last compressor element being higher, resulting in a higher temperature of the regeneration gas.

In this way, it can be avoided that moisture builds up in the dryer and the drying agent will always be fully regenerated.

Reducing the cooling capacity of the intercooler can be done in several ways.

A first way is to provide a bypass line over the intercooler such that it can be controlled how much of the compressed gas passes through the intercooler.

A second way is to control the flow rate of the intercooler coolant, for example cooling water. By passing a lower flow of refrigerant through the intercooler, the cooling capacity will be reduced.

A disadvantage of this method is that, by cooling the compressed gas less or by cooling only part of the compressed gas, less moisture is removed.

As a result, the compressed gas at the outlet of the last compressor element, and thus also the regeneration gas, will contain more moisture, which in turn has a negative influence on the regeneration of the drying agent.

In some circumstances, this will actually make the regeneration worse, as opposed to the situation where the intercooler has not reduced its cooling capacity.

The present invention aims to provide a solution to at least one of said and other drawbacks.

The present invention aims at a compressor installation provided with a compressor device with at least two compressor elements arranged in series, wherein the inlet of the last compressor element of the at least two compressor elements arranged in series is connected via a pressure line to the outlet of the penultimate compressor element of the at least two compressor elements arranged in series, wherein an outlet line is connected to the outlet of the last compressor element of the at least two compressor elements arranged in series, wherein an intercooler is provided in said pressure line, wherein the compressor installation is further provided with a dryer of the type using a drying agent or desiccant for drying the compressed gas originating from the compressor device, wherein the dryer is provided with a drying section with an inlet connected to said outlet line and with an outlet for dried compressed gas, and a regeneration section with an inlet and an outlet for a regeneration gas, wherein a regeneration line is connected to the inlet of the regeneration section, which departs from a branch point of the outlet line, characterized in that the compressor installation is further provided with a heat exchanger with a primary section located in said pressure line downstream of said intercooler for heating the compressed gas, wherein the device is provided with means for controlling the heating of the compressed gas by the heat exchanger, wherein the compressor installation is further provided with a control unit for controlling said means.

An advantage is that by providing a heat exchanger for heating the compressed gas before it enters the last compressor element, it is still possible to cool the compressed gas first and remove condensate, without the compressed gas having too low a temperature as a result of this cooling after the last compressor element to properly regenerate the drying agent.

Moreover, the cooling will allow condensate to be removed, such that the compressed gas after the last compressor element contains less moisture compared to the existing technique, wherein the compressed gas is cooled less after the penultimate compressor element.

By providing a control unit which will control said means, the control can take place automatically on the basis of a number of predetermined parameters.

According to a preferred feature of the invention, the secondary section of the heat exchanger is located upstream of the intercooler.

The secondary section can here be located both downstream and downstream of the penultimate compressor element.

In a practical embodiment, the secondary section of the heat exchanger is included in a bypass line on said pressure line upstream of the intercooler and said means are constituted by a control valve which is arranged either in the bypass line, or in the part of the pressure line that is bypassed by the bypass line.

In another practical embodiment, the secondary section of the heat exchanger is included in said pressure line upstream of the intercooler, wherein the primary section of the heat exchanger is bypassed via a bypass line and said means are formed by a control valve arranged either in said bypass line or in the pressure line between the intercooler and the primary section of the heat exchanger.

An advantage of such a method is that the heat exchanger can be designed smaller, because the entire flow rate of compressed gas is used for heating the compressed gas after the intercooler and because only a part of the compressed gas flows through the primary section.

In the most preferred embodiment, a chiller is included downstream of the intercooler and upstream of the primary section of the heat exchanger for deep cooling of the compressed gas.

By adding the chiller, the compressed gas is cooled to below ambient temperature, such that additional condensate can be separated off.

As a result, the compressed gas after the last compressor element and thus the regeneration gas will contain less moisture, such that the regeneration process will run more efficiently.

The invention also relates to a method for controlling a compressor device with at least two compressor elements arranged in series, wherein the compressed gas is passed through a drying agent in a drying section for drying the compressed gas, and wherein the drying agent is subsequently regenerated in a regeneration section by means of a regeneration gas passed through a regeneration section, wherein the regeneration gas is branched off from the compressed gas downstream of the last of the compressor elements arranged in series, characterized in that the method comprises the following steps:
A) cooling the compressed gas leaving the penultimate of the at least two compressor elements arranged in series;
B) subsequently heating the compressed gas before the compressed gas enters the last of the two compressor elements arranged in series;
C) controlling the heating of the compressed gas.

The advantages of this method are similar to those of the compressor device.

By first cooling the gas, whereby condensate can be removed, and subsequently heating the compressed gas, it can be ensured that the regeneration gas has a sufficiently high temperature, without still having a high humidity.

Preferably, after cooling the compressed gas leaving the penultimate of the at least two compressor elements arranged in series, the method comprises the step of deep cooling the compressed gas.

This will allow to extract even more moisture from the compressed gas, such that ultimately the regeneration gas will contain less moisture, such that the regeneration will proceed better.

The invention also relates to a compressor installation provided with a compressor device with at least two compressor elements arranged in series, wherein the inlet of the last compressor element of the at least two compressor elements arranged in series is connected via a pressure line to the outlet of the penultimate compressor element of the at least two compressor elements arranged in series, wherein an outlet line is connected to the outlet of the last compressor element of the at least two compressor elements arranged in series, wherein an intercooler is provided in said outlet pipe, wherein the compressor installation is further provided with a dryer of the type using a drying agent or desiccant for drying the compressed gas originating from the compressor device, wherein the dryer is provided with a drying section with an inlet connected to said outlet line and with an outlet for dried compressed gas, and a regeneration section with an inlet and an outlet for a regeneration gas, wherein a regeneration line is connected to the inlet of the regeneration section, which departs from a branch point of the outlet line, characterized in that the compressor installation is further provided with a heat exchanger which is included in a bypass line over said intercooler, wherein the compressor installation is provided with means for controlling the heating of the compressed gas by the heat exchanger, wherein the compressor installation is further provided with a control unit for controlling said means.

An advantage is that by providing a heat exchanger for heating at least part of the compressed gas before it enters the last compressor element, it is still possible to cool the remaining part of the compressed gas first and to remove condensate, without the compressed gas having too low a temperature, as a result of this cooling after the last compressor element, to be able to properly regenerate the drying agent.

Moreover, the cooling will allow condensate to be removed, such that the compressed gas after the last compressor element contains less moisture compared to the existing technique, wherein the compressed gas is cooled less after the penultimate compressor element.

By providing a control unit which will control said means, the control can take place automatically on the basis of a number of predetermined parameters.

In order to better demonstrate the features of the invention, some preferred variants of a method according to the invention for controlling a compressor installation and compressor installation are described below, by way of example without any limiting character, with reference to the accompanying drawings, in which:

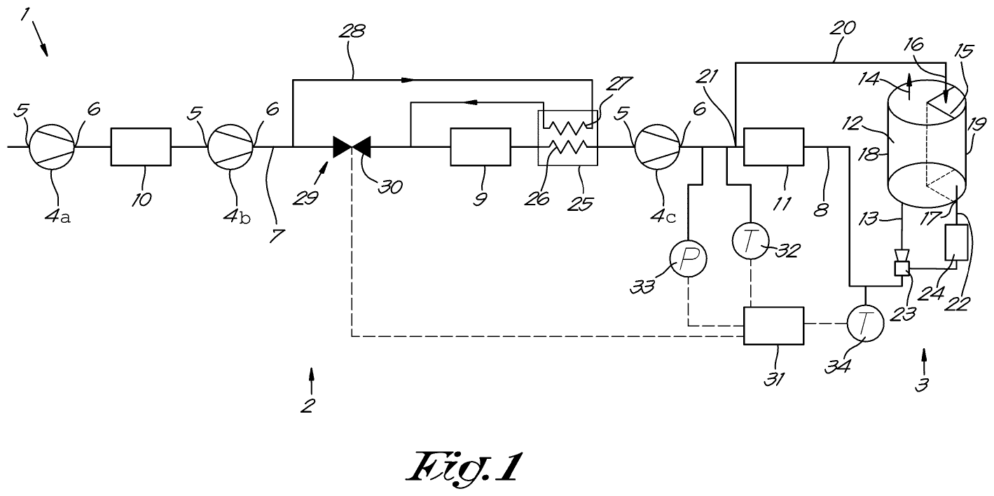

FIG. 1 schematically represents a compressor device according to the invention;

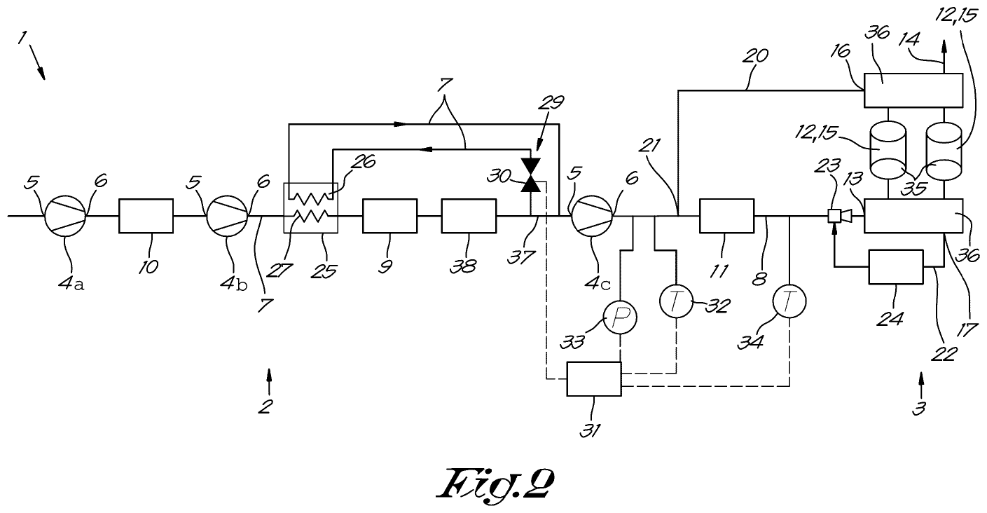

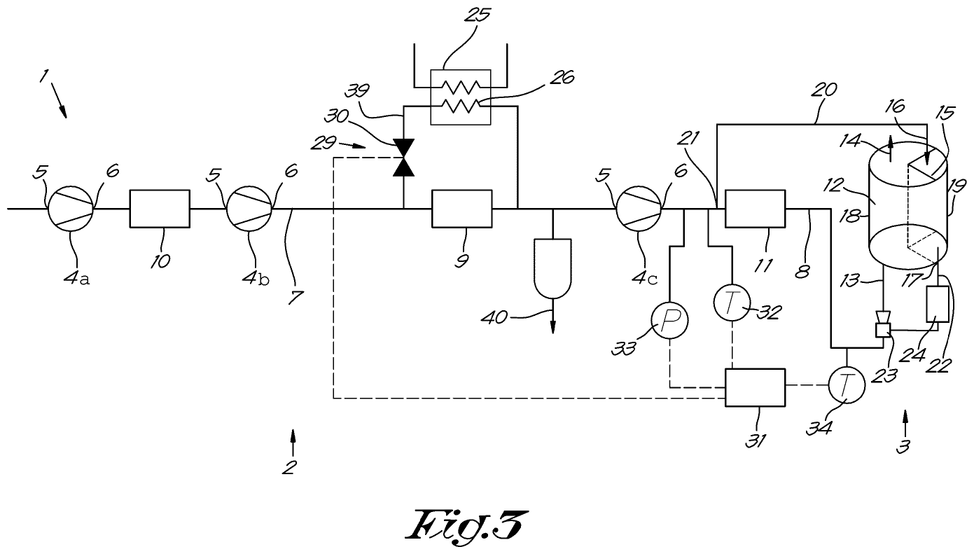

FIGS. 2 and 3 represent an alternative embodiment of the compressor device from FIG. 1.

The compressor installation 1 shown schematically in FIG. 1 comprises a compressor device 2 and a dryer 3.

In this case, the compressor device 1 comprises three compressor elements 4a, 4b, 4c arranged in series, each with an inlet 5 and an outlet 6, i.e. a first compressor element 4a, a penultimate compressor element 4b and a last compressor element 4c.

It is not excluded that said first compressor element 4a is absent or comprises several compressor elements 4a.

According to the invention, the inlet 5 of the last compressor element 4c is connected via a pressure line 7 to the outlet 6 of the penultimate compressor element 4b.

An outlet line 8 is connected to the outlet 6 of the last compressor element 4c.

In said pressure line 7, an intercooler 9 is provided for cooling the compressed gas.

In this case, an intercooler 10 is also provided between the first and the penultimate compressor element 4a, 4b.

In this case, but not necessary for the invention, an aftercooler 11 is provided.

The dryer 3 is of the type that uses a drying agent or desiccant for drying the compressed gas from the compressor device 2.

The dryer 3 is provided with a drying section 12 with an inlet 13 connected to said outlet line 8 and with an outlet 14 for dried compressed gas and a regeneration section 15 with an inlet 16 and an outlet 17 for a regeneration gas.

In this case, the dryer 3 is provided with a housing 18 within which the drying section 12 and the regeneration section 15 are located, wherein in the housing 18 a drum 19 containing the drying agent is arranged, which drum 19 is connected to drive means (not shown) in such a way that the drying agent can be moved successively through the drying section 12 and the regeneration section 15.

A regeneration line 20 is connected to the inlet 16 of the regeneration section 15, which departs from a branch point 21 of the outlet line 8. This branch point 21 is located upstream of said aftercooler 11.

In this case, a return line 22 is arranged on the outlet 17 of the regeneration section 15, which connects to the inlet 13 of the drying section 12. This connection is realized by means of a venturi ejector 23.

In this case, a cooler 24 is provided in the return line 22.

It will be appreciated that, instead of providing a return line 22, the regeneration gas can also be vented.

According to the invention, the compressor installation 1 is provided with a heat exchanger 25 for heating the compressed gas.

The primary section 26 of the heat exchanger is included in said pressure line 7, downstream of said intercooler 9.

In this embodiment, the secondary section 27 of the heat exchanger 25 is located upstream of the intercooler 9 and more specifically, the secondary section 27 of the heat exchanger 25 is included in a bypass line 28 on said pressure line 7 upstream of the intercooler 9. However, any location upstream of the intercooler 9 is possible.

In other words, the heat exchanger 25 will obtain its energy from the heat of compression, but this is not necessary for the invention.

According to the invention, the compressor installation 1 is provided with means 29 for controlling the heating of the compressed gas by the heat exchanger 25.

In this specific embodiment, these means 29 are formed by a control valve 30 which is arranged in the portion of the pressure line 7 which is bypassed by said bypass line 28.

The means 29 can also be arranged in the bypass line 28 itself.

Via these means 29, it is possible to regulate how much of the compressed gas flows through the secondary section 27 of the heat exchanger 25, or in other words: the capacity of the heat exchanger 25 can be regulated.

Said means 29 may also comprise a three-way valve arranged at a location where the bypass line 28 joins the pressure line 7.

In the embodiment of FIG. 1, the bypass line 28 is arranged on said pressure line 7 upstream of the intercooler 9.

It is also possible that bypass line 28 is arranged over the intercooler 9, i.e. the compressed gas, after it has passed through the secondary section 27, is added to the delivery line 7 at a point downstream of the intercooler 9 instead of upstream of the intercooler 9, as is the case in FIG. 1.

Furthermore, the compressor installation 1 is provided with a control unit 31 for controlling said means 29.

Finally, the compressor installation 1 is, in this case, provided with a number of sensors 32, 33, 34.

The term sensors 32, 33, 34 should be interpreted broadly in this context as general ‘measuring means’, which can measure or determine certain parameters.

Thus, the compressor installation 1, in this case, comprises a sensor 32 and 33 for determining the temperature and pressure of the compressed gas at the outlet 6 of the last compressor element 4c.

Hence, this is the temperature and pressure of the regeneration gas.

In this case, the sensor 32 is provided at the outlet 6 of the last compressor element 4c, such that this sensor 32 can directly measure the temperature of the regeneration gas.

However, it cannot be ruled out that the sensor 32 is arranged at the inlet 5 of the last compressor element 4c, whereby the temperature of the regeneration gas can be calculated on the basis of the measurement of the sensor 32.

The compressor installation 1 also comprises a sensor 34 for measuring the temperature of the compressed gas at the inlet 13 of the drying section 12.

The control unit 31 is connected to said sensors 32, 33, 34 and is configured to determine, based on the signals from said sensors 32, 33, 34, how much moisture enters the dryer 3, i.e. the amount of moisture in the compressed gas entering the drying section 12 minus the amount of moisture of the compressed gas leaving the drying section 12 or thus the amount of moisture absorbed by the drying agent, and how much moisture exiting the dryer 3, i.e. the amount of moisture in the regeneration gas entering the regeneration section 15 minus the amount of moisture of the regeneration gas that enters the regeneration section 15, or hence the amount of moisture that is withdrawn from the drying agent, and to actuate, on this basis, the means 29. This is explained in more detail below.

In principle, the sensor 33 and the sensor 34 are optional, i.e. they are not necessary to control the means 29. However, by providing one or both of these sensors 33, 34, the control will be much more accurate.

The operation of the compressor installation 1 is very simple and as follows.

The compressor elements 4a, 4b, 4c will compress gas, for example ambient air.

After the first compressor element 4a, the compressed gas passes through the intercooler 10 to cool the gas and separate off the condensate.

After the penultimate compression stage 4b, a portion of the compressed gas is branched off and directed to the secondary section 27 of the heat exchanger 25 and then re-joins the compressed gas to further be directed to the intercooler 9.

The compressed gas is cooled in this intercooler 9, where condensate can be separated off.

After passing through the intercooler 9, the compressed gas ends up in the primary section 26 of the heat exchanger 25 and is reheated.

In this case, use is made of the heat of the compressed gas upstream of the respective intercooler 9 to reheat the compressed gas, but it is not excluded that the heat of the compressed gas is used upstream of the penultimate compressor element 4b or that another heat source is used.

Subsequently, the reheated compressed gas is passed through the last compressor element 4c.

After this, a portion of the compressed gas is branched off through the regeneration line 20 as regenerating gas and directed to the regeneration section 15 where the moisture will be extracted from the drying agent, while the rest of the compressed gas is passed through the aftercooler 11 to the inlet 13 of the drying section 12.

After passing through the regeneration section, the now moist regeneration gas is returned via the return line 22 to the inlet 13 of the drying section 12.

The compressed gas subsequently passes through the drying section 12, and the dried compressed gas leaves the compressor installation 1 through the outlet 14.

To control how much of the compressed gas is directed to the secondary section 27 of the heat exchanger 25 after the penultimate compressor element 4b, the control valve 30 is controlled by the control unit 31.

By directing more compressed gas to the heat exchanger 25, the compressed gas is heated more, such that the compressed gas after the last compression stage 4c and hence, also the regeneration gas will also have a higher temperature, with the result that the regeneration of the drying agent is more optimal or will proceed better. In other words, controlling the heating of the compressed gas and controlling the temperature of the regeneration gas can be done by controlling the control valve 30.

The control unit 31 will determine what temperature of the regeneration gas is required.

To this end, the control unit 31 will determine how much moisture enters the dryer 3 i.e. the amount of moisture in the compressed gas entering the drying section 12 minus the amount of moisture of the compressed gas leaving the drying section 12 or hence the amount of moisture absorbed by the drying agent, and how much moisture leaves the dryer 3, i.e. the amount of moisture in the regeneration gas leaving the regeneration section 15 minus the amount of moisture of the regeneration gas entering the regeneration section 15 or thus the amount of moisture withdrawn from the drying agent.

The control unit 31 will herein use the signals from said sensors 32, 33, 34. It is also possible that the control unit 31 determines this in a different way, for instance by making use of other sensors and/or sensors at other locations.

The control unit 31 will set the temperature of the regeneration gas such that the moisture entering the dryer 3 is equal to or within a certain margin equal to the moisture exiting the dryer 3.

If too little moisture leaves the dryer 3, the control unit 31 will increase the temperature of the regeneration gas by adjusting the control valve 30 appropriately. The regeneration of the saturated drying agent will proceed better, allowing more moisture to be extracted from the drying agent.

In this way, it can be ensured that little or no moisture remains in the dryer 3. This will ensure the proper functioning of the dryer.

FIG. 2 shows a variant according to FIG. 1, wherein, in this case, firstly the dryer 3 comprises a number of vessels 35 filled with the drying agent, of which at least one vessel 35 constitutes the drying section 12 and at least one vessel 35 constitutes the regeneration section 15.

In this case, there are two vessels 35, one of which constitutes the drying section 12 and another the regeneration section 15.

The dryer 3 further comprises a valve system 36 which connects the inlet 13 and 16 respectively, and outlet 14 and 17 respectively of the drying section 12 and of the regeneration section 15 to said vessels 35, wherein said valve system 36 is such that at least one vessel 35 is always regenerated, while the other vessels 35 dry the compressed gas, wherein by controlling the valve system 36, the vessels 35 are each in turn successively regenerated.

Furthermore, in this case, the secondary section 27 is included in the pressure line 7 itself, upstream of the intercooler 9.

The primary section 26 of the heat exchanger 25 is, in this case, bypassed via a bypass line 37.

Said means 29 are formed by a control valve 30 which is arranged in the pressure line 7 between the intercooler 9 and the primary section 26 of the heat exchanger 25.

However, said means 29 can also be arranged in said bypass line 37.

Finally, the compressor installation 1 downstream of the intercooler 9 and upstream of the primary section 26 of the heat exchanger 25 is provided with a chiller 38 for deep cooling of the compressed gas.

The operation of the device 1 of FIG. 2 is very similar to that of FIG. 1.

In this case, the compressed gas will be passed, after the intercooler 9, through the chiller 38, where it is further cooled to below the ambient temperature.

As a result, even more moisture will condense and the compressed gas will be drier.

After the intercooler 9, a portion of the gas is passed through the heat exchanger 25 to be heated, using the heat of compression after the penultimate compressor element.

By controlling the control valve 30, it will be possible to control how much gas is heated and how much gas is directed directly to the last compressor element 4c via the bypass line 37, and thus also the temperature of the compressed gas entering the last compressor element 4c can be controlled and thus also the temperature of the regeneration gas.

The control unit 31 will also apply a control as described above in this embodiment.

FIG. 3 shows a second alternative embodiment of FIG. 1, wherein, in this case, instead of a bypass line 28, a bypass line 39 is provided.

The heat exchanger 25 is provided in the bypass line 39, its primary section 26 being included in the bypass line 39.

Furthermore, means 29 are provided, in the form of a control valve 30, for controlling how much compressed gas passes through the intercooler 9.

The compressor installation 1 is also provided with means 40 for separating off condensate, said means 40 being located downstream of the intercooler 9.

These means 40 are, in this case, a condensate separator.

For the rest, the device is the same as that shown in FIG. 1.

The operation of this embodiment is similar as described above, but, in this case, it will be controlled which part of the compressed gas is cooled and which part is heated.

A condensate separator 40 can also be provided in the embodiment of FIG. 1 and FIG. 2. In FIG. 1, this condensate separator 40 is preferably positioned downstream of the intercooler 9 and upstream of the primary section 26. In FIG. 2, preferably downstream of the chiller 38 and upstream of the primary section 36 and the bypass line 37.

The present invention is by no means limited to the embodiments described by way of example and shown in the figures, but such a method for controlling a compressor installation and compressor installation can be realized according to different variants without departing from the scope of the invention.

1-20. (canceled)

21. A compressor installation comprising:
a compressor device with at least two compressor elements arranged in series,
wherein the inlet of the last compressor element of the at least two compressor elements arranged in series is connected via a pressure line to the outlet of the penultimate compressor element of the at least two compressor elements arranged in series,
wherein an outlet line is connected to the outlet of the last compressor element of the at least two compressor elements arranged in series,
wherein an intercooler is provided in said pressure line,
wherein the compressor installation is further provided with a dryer of the type using a drying agent or desiccant for drying the compressed gas originating from the compressor device,
wherein the dryer is provided with a drying section with an inlet connected to said outlet line and with an outlet for dried compressed gas, and a regeneration section with an inlet and an outlet for a regeneration gas, wherein the inlet of the regeneration section is connected to a regeneration line which departs from a branch point of the outlet line,
wherein the compressor installation is further provided with a heat exchanger with a primary section located in said pressure line downstream of said intercooler for heating the compressed gas,
wherein the compressor installation is provided with means for controlling the heating of the compressed gas by the heat exchanger,
wherein the compressor installation is further provided with a control unit for controlling said means.

22. The compressor installation according to claim 21, wherein a secondary section of the heat exchanger is located upstream of the intercooler.

23. The compressor installation according to claim 22, wherein the secondary section of the heat exchanger is included in a bypass line on said pressure line upstream of the intercooler.

24. The compressor installation according to claim 21, wherein a secondary section of the heat exchanger is included in a bypass line on said pressure line arranged over the intercooler.

25. The compressor installation according to claim 23, wherein said means are formed by:
a control valve arranged either in the bypass line or in the section of the pressure line bypassed by the bypass line; or by:
a three-way valve arranged at a location where the bypass line joins the pressure line.

26. The compressor installation according to claim 22, wherein the secondary section of the heat exchanger is included in said pressure line upstream of the intercooler, wherein the primary section of the heat exchanger is bypassed via a bypass line, and in that said means are formed by a control valve arranged either in said bypass line or in the pressure line between the intercooler and the primary section of the heat exchanger.

27. The compressor installation according to claim 21, wherein a chiller is included downstream of the intercooler and upstream of the primary section of the heat exchanger, for deep-cooling the compressed gas.

28. The compressor installation according to claim 21, wherein the compressor installation is provided with means for separating off condensate, wherein said means are located downstream of the intercooler.

29. The compressor installation according to claim 21, wherein the dryer is provided with a housing within which the drying section and the regeneration section are located, wherein in the housing a drum is arranged containing the drying agent, which drum is connected to drive means such that the drying agent can be moved successively through the drying section and the regeneration section.

30. The compressor installation according to claim 21, wherein the dryer comprises a number of vessels filled with the drying agent, of which at least one vessel constitutes the drying section and at least one vessel constitutes the regeneration section, wherein the dryer further comprises a valve system connecting the inlet and outlet of the drying section and of the regeneration section to said vessels, wherein said valve system is such that at least one vessel is always regenerated, while the other vessels dry the compressed gas, whereby by regulating the valve system the vessels are each in turn successively regenerated.

31. The compressor installation according to claim 21, wherein a return line is arranged on the outlet of the regeneration section which connects to the inlet of the drying section.

32. The compressor installation according to claim 21, wherein an aftercooler is arranged in the outlet line downstream of said branch point of the regeneration line.

33. The compressor installation according to claim 21, wherein the compressor installation is further provided with sensors to determine, to measure or to calculate the temperature of the compressed gas at the outlet of the last compressor element of the at least two compressor elements arranged in series, wherein the control unit is configured to determine, based on the signals from said sensors, how much moisture enters the dryer and how much moisture leaves the dryer, and based thereon to control the means.

34. The compressor installation according to claim 33, wherein the compressor installation is additionally provided with a sensor for measuring the temperature of the compressed gas at the inlet of the drying section, and/or with a sensor to determine the pressure of the compressed gas at the outlet of the last compressor element of the at least two compressor elements arranged in series, wherein the control unit is configured to determine, on the basis of the signals from said sensors, how much moisture enters the dryer and how much moisture leaves the dryer, and based thereon to control the means.

35. A method of controlling a compressor device with at least two compressor elements arranged in series, wherein the compressed gas is passed through a drying agent in a drying section for drying the compressed gas, and wherein the drying agent is subsequently regenerated in a regeneration section by means of a regeneration gas passed through a regeneration section, wherein the regeneration gas is branched off from the compressed gas downstream of the last compressor element of the at least two compressor elements arranged in series, the method comprising the following steps:
cooling the compressed gas leaving the penultimate compressor element of the at least two compressor elements arranged in series;
subsequently heating the compressed gas before the compressed gas enters the last compressor element of the at least two compressor elements arranged in series;
controlling the heating of the compressed gas.

36. The method according to claim 35, wherein, for heating the compressed gas, use is made of the heat of the compressed gas upstream of the last compressor element of the at least two compressor elements arranged in series.

37. The method according to claim 35, wherein the step of controlling the heating of the compressed gas consists in determining how much moisture enters the dryer and how much moisture leaves the dryer and based thereon to control the temperature of the compressed gas.

38. The method according to claim 35, wherein a heat exchanger is used to heat the compressed gas.

39. The method according to claim 35, wherein after cooling the compressed gas leaving the penultimate compressor element of the at least two compressor elements arranged in series, the method comprises the step of deep-cooling the compressed gas.

40. A compressor installation comprising:
a compressor device with at least two compressor elements arranged in series,
wherein the inlet of the last compressor element of the at least two compressor elements arranged in series is connected via a pressure line to the outlet of the penultimate compressor element of the at least two compressor elements arranged in series,
wherein an outlet line is connected to the outlet of the last compressor element of the at least two compressor elements arranged in series,
wherein an intercooler is provided in said pressure line,
wherein the compressor installation is further provided with a dryer of the type using a drying agent or desiccant for drying the compressed gas originating from the compressor device,
wherein the dryer is provided with a drying section with an inlet connected to said outlet line and with an outlet for dried compressed gas, and a regeneration section with an inlet and an outlet for a regeneration gas,
wherein a regeneration line is connected to the inlet of the regeneration section, which departs from a branch point of the outlet line,
wherein the compressor installation is further provided with a heat exchanger included in a bypass line over said intercooler,
wherein the compressor installation is provided with means for controlling the heating of the compressed gas by the heat exchanger,
wherein the compressor installation is further provided with a control unit for controlling said means.
